(19) United States
(12) Patent Application Publication
(10) Pub. No.: US 2009/0073491 A1
(43) Pub. Date: Mar. 19, 2009

(54) INFORMATION PROCESSING APPARATUS, INFORMATION PROCESSING METHOD, AND IMAGE PROCESSING APPARATUS

(76) Inventor: Hisanori KAWAURA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/202,508

(22) Filed: Sep. 2, 2008

(30) Foreign Application Priority Data
Sep. 14, 2007 (JP) 2007-239566

(51) Int. Cl. G06F 15/00

(52) U.S. Cl. 358/1.16

(57) ABSTRACT

A storage unit stores therein license information that indicates whether an application is licensed and permission information that indicates whether an application is allowed to start. A starting unit starts an application for which the permission information is stored in the storage unit. A determining unit acquires license information of a running application from the storage unit and determines whether acquired license information indicates that the application is licensed. An outputting unit outputs error information when the acquired license information does not indicate that the running application is licensed.

### CROSS-REFERENCE TO RELATED APPLICATIONS

The present application claims priority to and incorporates by reference the entire contents of Japanese priority document 2007-239566 filed in Japan on Sep. 14, 2007.

### BACKGROUND OF THE INVENTION

1. Field of the Invention

The present invention relates to an information processing apparatus, an information processing method, and an image processing apparatus.

2. Description of the Related Art

A NAND flash memory is increasingly used with a sophisticated electronic device such as a high-megapixel digital camera or an ultra compact portable digital audio player because NAND flash memory can meet a recent demand for high capacity and high write speed storage media. Meanwhile, a multifunction peripheral (MFP) is being sophisticated to serve a number of functions, so that a size of firmware that controls the MFP is increasing. The MFP has employed NOR flash memory as a storage medium that stores therein the firmware. However, NOR flash memory is relatively expensive but has only low capacity, so that NAND flash memory that is relatively cheap and has high capacity is increasingly used, instead of NOR flash memory, in the MFP.

Generally, manufactures of the MFP provide a plurality of models with different functions within a single product line so that various customers' needs about functions, prices, or the like can be satisfied. If the models are differentiated from one another based on physical configurations, that is, if parts such as an HDD or a network card depend on the models, it is relatively easy to manage parts during production.

On the other hand, if the models are differentiated from one another based on firmware that controls each model, it is necessary to install different firmware on controller boards depending on the models. However, controller boards look the same to one another even if each controller board contains different firmware, so that mismounting of the controller boards onto different models may occur during production.

One countermeasure is to store all firmware in a storage medium in advance in the MFP, so that only licensed firmware is activated when the MFP is in a maintenance mode. With this technology, it is not necessary to individually install firmware on a controller board for each different model.

For example, Japanese Patent Application Laid-open. No. 2003-51905 discloses a technology for easily activating data by simplifying necessary operation. Specifically, a setting sheet that contains setting information about a password or the like is provided as a mark sensing card or a barcode, so that when activating data such as software programs or font data, necessary operation such as inputting of a password or setting of various installations can be easily performed by using the setting sheet.

In this technology, all firmware including optional firmware used for enhancing functions can be stored in one storage medium although the optional firmware has originally been provided by different storage media. Therefore, the technology is advantageous in that production costs of storage media for the optional firmware can be reduced.

However, when all firmware is installed in advance in an MFP and only permitted firmware is to be activated later, unpermitted firmware may be erroneously activated by an operational error.

For example, assume that a model change that needs to stop particular firmware is performed on an MFP as maintenance by an operator (e.g., serviceman) such that an in-house manufactured printer is deactivated so that an extensible firmware interface (EFI) printer controller is connected. If license information indicating whether the in-house printer is allowed to run is deleted by mistake, it is difficult to determine whether the in-house printer can be activated when the EFI printer controller is disconnected. Thus, unpermitted firmware may be erroneously activated by an operational error. Furthermore, if information about how to activate firmware is leaked, unpermitted firmware may be fraudulently activated.

### SUMMARY OF THE INVENTION

It is an object of the present invention to at least partially solve the problems in the conventional technology.

According to an aspect of the present invention, there is provided an information processing apparatus including a storage unit that stores therein license information that indicates whether an application is licensed and permission information that indicates whether an application is allowed to start; a starting unit that starts an application for which the permission information is stored in the storage unit; a determining unit that acquires license information of a running application from the storage unit and determines whether acquired license information indicates that the application is licensed; and an outputting unit that outputs error information when the acquired license information does not indicate that the running application is licensed.

Furthermore, according to another aspect of the present invention, there is provided an information processing method including starting an application for which the permission information that indicates whether an application is allowed to start is stored in a storage unit that stores therein license information that indicates whether an application is licensed and permission information; determining including acquiring license information of a running application from the storage unit, and determining whether acquired license information indicates that the application is licensed; and outputting error information when the acquired license information does not indicate that the running application is licensed.

Moreover, according to still another aspect of the present invention, there is provided an image processing apparatus including a plurality of applications for processing an image using hardware resources, an operating system, and a control unit that runs on the operating system to control the hardware resources in response to an access from each of the applications. The image processing apparatus further includes a storage unit that stores therein license information that indicates whether an application is licensed and permission information that indicates whether an application is allowed to start; a starting unit that starts an application for which the permission information is stored in the storage unit; a determining unit that acquires license information of a running application from the storage unit and determines whether acquired license information indicates that the application is licensed; and an outputting unit that outputs error information when the acquired license information does not indicate that the running application is licensed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a hardware configuration of a multifunction peripheral (MFP) according to a first embodiment of the present invention;

FIG. 2 is a functional block diagram of the MFP shown in FIG. 1;

FIG. 3 is an example of an operation panel shown in FIG. 1;

FIG. 4 is a schematic diagram of a data structure of a license flag and an application start flag according to the first embodiment;

FIG. 5 is a flowchart of an application start process according to the first embodiment;

FIG. 6 is a flowchart of an application start check process according to the first embodiment;

FIG. 7 is a flowchart of a flag determination process according to the first embodiment;

FIG. 8 is a flowchart of a license process according to the first embodiment;

FIG. 9 is a flowchart of a start-flag change process according to the first embodiment;

FIG. 10 is a functional block diagram of an MFP according to a second embodiment of the present invention;

FIG. 11 is a schematic diagram of a data structure of an application set mode flag according to the second embodiment;

FIG. 12 is a flowchart of an application start process according to the second embodiment;

FIG. 13 is a flowchart of a set flag change process according to the second embodiment;

FIG. 14 is a schematic diagram of a network configuration of a communication system according to a third embodiment of the present invention;

FIG. 15 is a functional block diagram of an MFP according to the third embodiment;

FIG. 16 is a flowchart of an application start process according to the third embodiment;

FIG. 17 is a flowchart of a license process according to the third embodiment;

FIG. 18 is a functional block diagram of an MFP according to a fourth embodiment of the present invention; and

FIG. 19 is a flowchart of an application start process according to the fourth embodiment.

### DETAILED DESCRIPTION OF THE PREFERRED EMBODIMENTS

Exemplary embodiments of the present invention are explained in detail below with reference to the accompanying drawings.

An information processing apparatus according to a first embodiment of the present invention stores a license flag and an application start flag in a nonvolatile memory and compare the flags with each other to check whether an application is fraudulently started. The license flag indicates whether an application is licensed. The application start flag indicates whether an application is allowed to run.

In the following embodiments, it is assumed that the information processing apparatus is a multifunction peripheral (MFP) having a copy function, a facsimile (FAX) function, a printer function, a scanner function, and a function for distributing an input image (an image read by the scanner function or input by the printer function or the FAX function). However, the present invention can be applied to other devices instead of MFPs as long as the devices can set information indicative of validity of an application and run only a valid application based on set information.

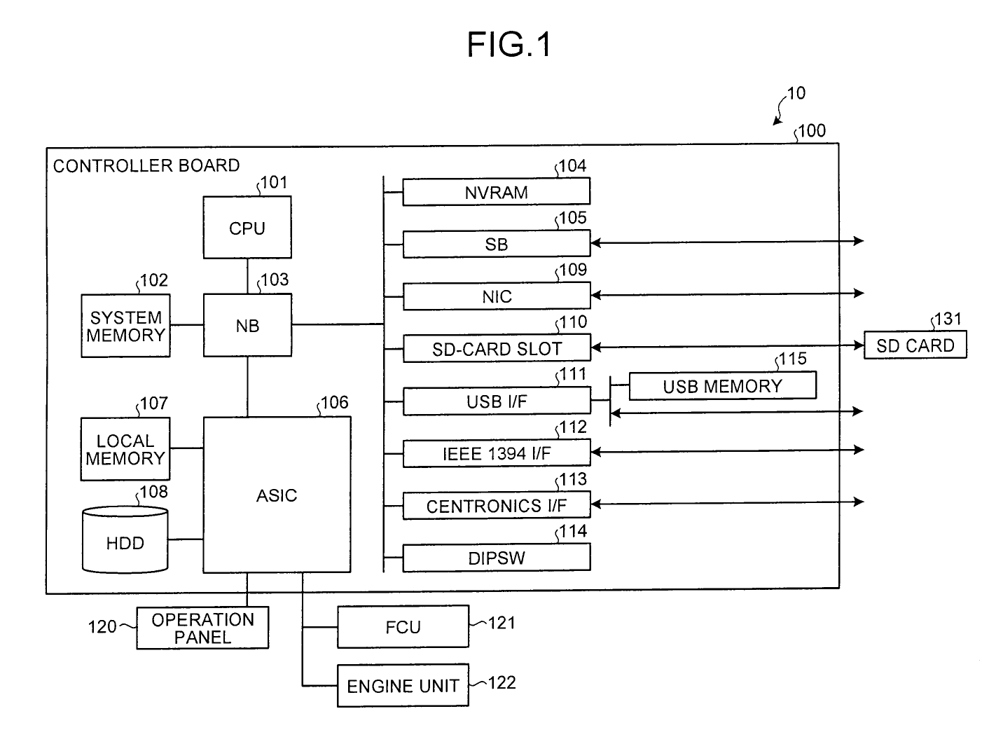

FIG. 1 is a block diagram of a hardware configuration of an MFP 10 according to the first embodiment. The MFP 10 includes a controller board 100, an operation panel 120, a FAX control unit (FCU) 121, and an engine unit 122. The controller board 100 includes a CPU 101, a system memory 102, a northbridge (NB) 103, a nonvolatile random access memory (NVRAM) 104, a southbridge (SB) 105, an application-specific integrated circuit (ASIC) 106, a local memory 107, a hard disk drive (HDD) 108, a network interface card (NIC) 109, an SD-card slot 110, a USB interface (I/F) 111, an IEEE 1394 I/F 112, a centronics I/F 113, and a dip switch (DIPSW) 114.

The CPU 101 controls the MFP 10. Specifically, the CPU 101 starts and runs processes on an OS of the MFP 10. The NB 103 is a bridge. The NVRAM 104 is a nonvolatile memory that stores therein the license flag and the application start flag. The SB 105 is a bridge that connects a PCI bus (not shown) to a ROM (not shown) or a peripheral device (not shown). The system memory 102 serves as a video random access memory or the like in the MFP 10. The system memory 102 stores therein model information, such as a product model number or a model number. The local memory 107 serves as a copy image buffer or a code buffer.

The ASIC 106 is an IC that includes hardware elements used for image processing. The HDD 108 is one of storage media (auxiliary storages) that store therein image data, text data, computer programs, font data, and the like. The NIC 109 is an interface device that connects the MFP 10 to a network (not shown).

An SD card 131 is configured to be inserted into the SD-card slot 110. That is, the SD card 131 is mounted on the MFP 10 when inserted into the SD-card slot 110. The SD-card slot 110 performs interrupt operation on an SD card status monitor driver (not shown) in response to insertion or removal of the SD card 131. The USB I/F 111, the IEEE 1394 I/F 112, and the centronics I/F 113 are interfaces compliant to specifications, respectively. The USB I/F 111 is configured to be connected to a USB memory 115. The DIPSW 114 indicates whether to start a license issuing application 216. Whether to start an application can be indicated by a jumper pin and the like, instead of the DIPSW 114. The USB memory 115 is a readable and writable nonvolatile storage medium. The USB memory 115 is fixedly mounted on the MFP 10 in the first embodiment, but not thus limited. The USB memory 115 stores therein computer programs executed by a software group 210 and an MFP starting unit 240. The software group 210 and the MFP starting unit 240 will be explained in detail later.

The operation panel 120 receives input from an operator and displays data to the operator. The FCU 121 includes a memory (not shown) that temporarily stores therein FAX data and the like received while the MFP 10 is powered OFF.

The SD card 131 is a readable and writable nonvolatile storage medium to be inserted to and removed from the MFP 10. The SD card 131 stores therein an SD card serial ID for identifying the SD card 131.

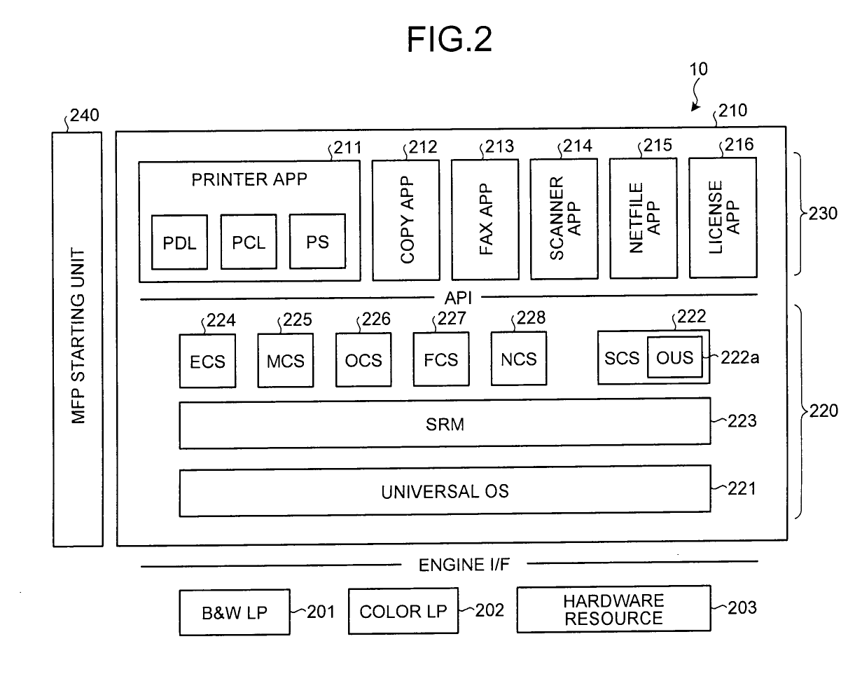

FIG. 2 is a functional block diagram of the MFP 10. The MFP 10 includes a black and white line printer (B&W LP) 201, a color LP 202, a hardware resource 203, the software group 210, and the MFP starting unit 240. Examples of the hardware resource 203 include a scanner, a FAX, a memory, and a network interface. The software group 210 includes a platform 220 and an application 230.

The platform 220 includes a control service (described in detail below), a system resource manager (SRM) 223, and a universal operating system (OS) 221. The control service interprets a processing request from the application 230 and issues an allocation request for allocating hardware resources. The SRM 223 manages one or more hardware resources and arbitrates allocation requests received from the control service.

The control service includes at least one of the following service modules: a system control service (SCS) 222, an engine control service (ECS) 224, a memory control service (MCS) 225, an operation panel control service (OCS) 226, a FAX control service (FCS) 227, and a network control service (NCS) 228.

The platform 220 includes an application program interface (API) that receives a processing request from the application 230 based on a predefined function.

The OS 221 is a universal OS such as UNIX (registered trademark) and performs parallel execution on software of the platform 220 and the application 230 as processes.

A process of the SRM 223 controls a system and manages resources in cooperation with the SCS 222. Specifically, the process of the SRM 223 performs arbitration and controls execution in response to a request from an upper layer (not shown) that uses hardware resources such as an engine, a memory, an HDD file, and a host I/O (centronics I/F, network I/F, IEEE1394 I/F, RS232C I/F, or the like) of the scanner and the printer.

More specifically, the SRM 223 determines whether a requested hardware resource is available (whether the hardware resource is not being used based on other requests). If the requested hardware resource is available, the SRM 223 sends a notice indicating that the requested hardware resource is available to the upper layer. The SRM 223 performs scheduling to determine order of use of the hardware resources in response to a request from the upper layer. For example, the SRM 223 causes a printer engine (not shown) to directly execute requested operation such as sheet feeding operation, imaging operation, memory allocation, or file generation.

A process of the SCS 222 performs operation such as application management, control of an operating unit (not shown), display of a system screen, display of data on an LED display, resource management, and interrupt application control. Processing executed by the SCS 222 will be described later.

The SCS 222 includes an on-demand update service (OUS) 222a. The OUS 222a changes a mode to a firmware update mode for updating firmware of the MFP 10 based on a predetermined condition, and controls processing in the firmware update mode.

A process of the ECS 224 controls engines of the hardware resource 203 that includes the B&W LP 201, the color LP 202, the HDD 108, the NVRAM 104, the scanner, and the FAX.

A process of the MCS 225 performs operation such as reservation and release of an image memory, use of the HDD 108, or compression and extension of image data. A process of the OCS 226 controls the operation panel 120 that serves as an information communication unit between an operator and the MFP 10.

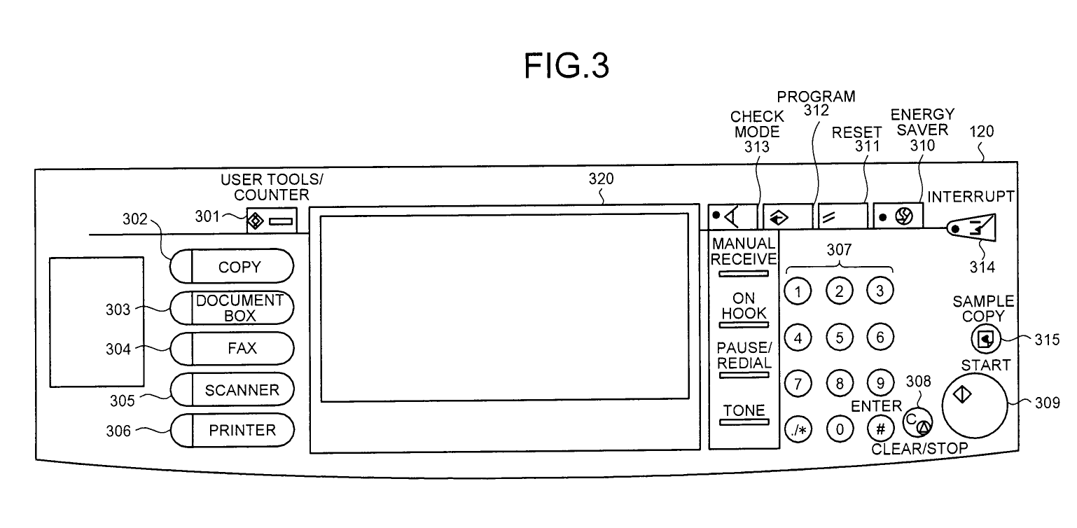

FIG. 3 is an example of the operation panel 120 to be controlled by the OCS 226. The operation panel 120 includes a user tools/counter key 301, a copy key 302, a document box key 303, a FAX key 304, a scanner key 305, a printer key 306, a numeric keypad 307, a clear/stop key 308, a start key 309, an warmup key 310, a reset key 311, a program key 312, a check mode key 313, an interrupt key 314, a sample copy key 315, and a liquid-crystal-display (LCD) touch panel 320.

When the user tools/counter key 301 is touched, a default setting menu is displayed on the LCD touch panel 320. In the default setting menu, various settings such as a size of a sheet to be stored in the MFP 10 can be made. Upon touching other keys, menus corresponding to the keys are displayed on the LCD touch panel 320. Specifically, upon touching the copy key 302 for copying, the document box key 303 for storing an outcome of copying in the MFP 10, the FAX key 304 for transmitting a fax sheet or a stored image, the scanner key 305 for scanning a document, or the printer key 306 for performing printing operation depending on operators' need, menus corresponding to each key is displayed on the LCD touch panel 320.

Referring back to FIG. 2, continued explanation is given below. A process of the FCS 227 provides an application that performs operation such as FAX transmission from each application layer of a system controller via PSTN or ISDN, registration or reference to FAX data managed by a backup SRM (BKM), read of FAX data, printing of received FAX data, or execution of integrated communication.

A process of the NCS 228 provides a shared service to be commonly used by all applications that require network I/Fs. The process of the NCS 228 relays data between an application and a network when receiving data from the network using various protocols, allocating data received from the network to a designated application, or transmitting data from the application to the network.

The application 230 includes a printer application 211, a copy application 212, a FAX application 213, a scanner application 214, a netfile application 215, and the license issuing application 216. The printer application 211 is used for a printer and configured based on page description language (PDL), printer control language (PCL), and post script (PS). The copy application 212 is used for copying. The FAX application 213 is used for FAX communication. The scanner application 214 is used for scanning. The netfile application 215 is used for network files. The license issuing application 216 stores a license flag and an application start flag of each of the applications 211 to 215 in the NVRAM 104.

Processes of the application 230 and processes of the control service perform inter-process communication containing extraction of functions, transmission of a returned value, and transmission of a message. Thus, user services related to image forming processing, such as a copy service, a printer service, a scanner service, and a FAX service, are realized.

As described above, the MFP 10 includes the application 230 and the control services that run as processes. In each of the processes, at least one thread is generated and parallel execution is performed for each thread. The control service provides a shared service to the application 230, so that the processes perform inter-process communication in cooperation with each other based on parallel execution performed on the processes and threads. As a result, a user service related to image forming processing, such as a copy service, a printer service, a scanner service, and a FAX service, is realized.

The MFP starting unit 240 is firstly started when the MFP 10 is powered ON. Then, the MFP starting unit 240 starts the application 230 and the platform 220. Specifically, the MFP starting unit 240 reads computer programs of the control service and the application 230 from the USB memory 115, transfers read computer programs to a memory area allocated on an SRAM or an SDRAM, and runs transferred computer programs.

The MFP starting unit 240 refers to the application start flag stored in the NVRAM 104 and starts the application that is allowed to run. Furthermore, when the DIPSW 114 indicates that the license issuing application 216 is allowed to run, the MFP starting unit 240 starts the license issuing application 216. This processing will be described in detail later.

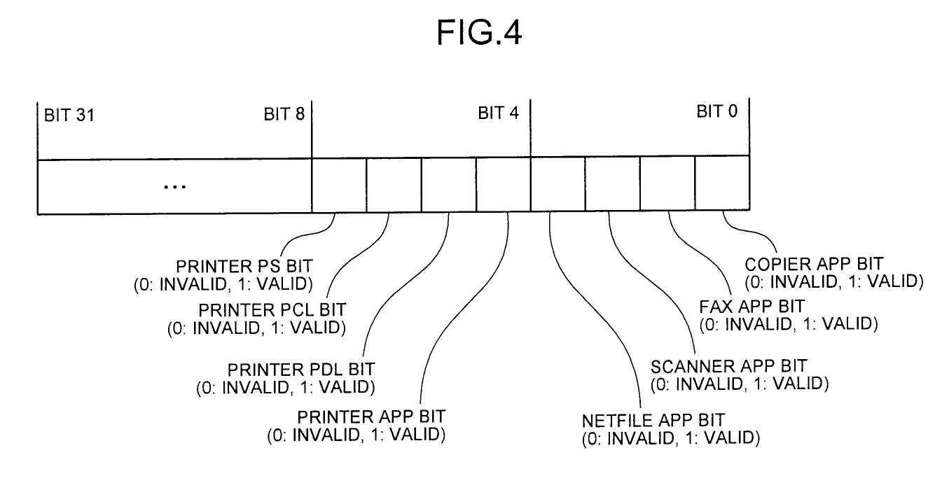

A data structure of each of the license flag and the application start flag stored in the NVRAM 104 by the license issuing application 216 is described with reference to FIG. 4. FIG. 4 is a schematic diagram of a data structure of each of the license flag and the application start flag stored in a predetermined 32-bit area in the NVRAM 104. That is, each of the license flag and the application start flag has a data structure as shown in FIG. 4 and is stored in each different area in the NVRAM 104.

Specifically, each of the flags contains a copy application bit, a FAX application bit, a scanner application bit, a netfile application bit, a printer application bit, a printer PDL bit, a printer PCL bit, and a printer PS bit.

Each of the above bits indicates that a corresponding application is invalid when the bit is set to “0” and valid when the bit is set to “1”. In the license flag, invalid means that the application is not licensed and valid means that the application is licensed. In the application start flag, invalid means that the application is not allowed to run and valid means that the application is allowed to run.

The license flag and the application start flag are stored in an area that is managed by the OS 221 and exclusively used for the license flag and the application start flag. That is, the area is separated from other areas in the NVRAM 104 used by other applications. Therefore, it is possible to prevent the flags from being changed by an operational error on other applications.

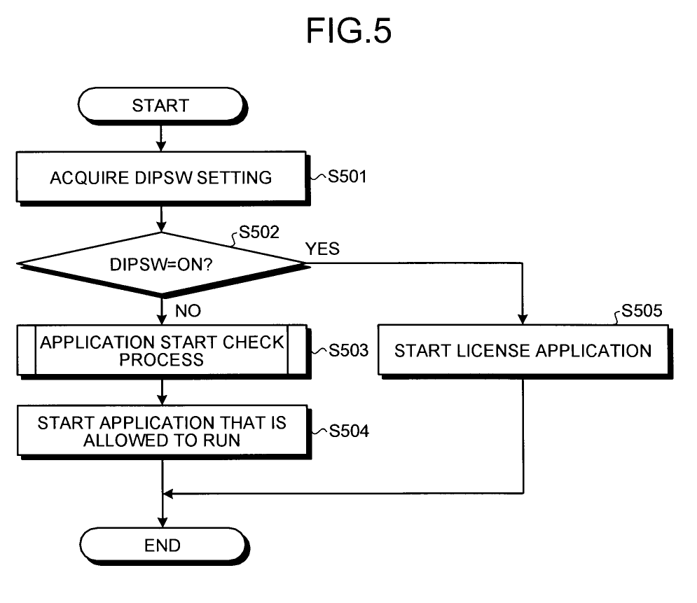

FIG. 5 is a flowchart of an application start process performed by the MFP 10. In the application start process, settings of the DIPSW 114 and the application start flag in the NVRAM 104 are checked at the time of power ON and an application is started based on the setting.

The MFP starting unit 240 acquires a setting of the DIPSW 114 (Step S501). Then, the MFP starting unit 240 determines whether the DIPSW 114 is ON, that is, whether the license issuing application 216 is allowed to run (Step S502).

When the DIPSW 114 is not ON (No at Step S502), the MFP starting unit 240 performs an application start check process for determining what application is allowed to run (Step S503). The application start check process is described in detail later.

After the application start check process, the MFP starting unit 240 starts an application that is allowed to run (Step S504), and process control ends.

When the DIPSW 114 is ON (Yes at Step S502), the MFP starting unit 240 starts the license issuing application 216 (Step S505), and process control ends.

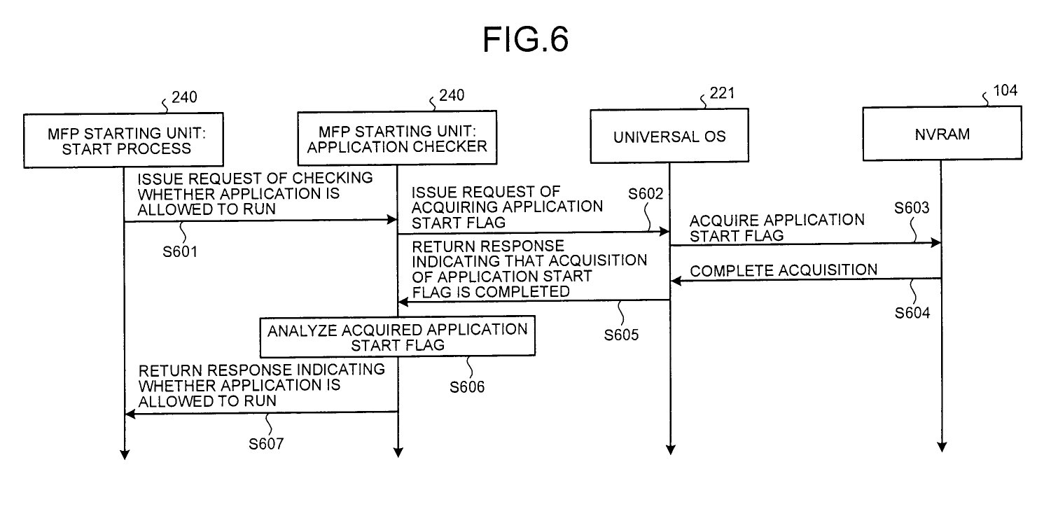

The application start check process at Step S503 is described below. FIG. 6 is a flowchart of the application start check process.

A start process that controls start processing in the MFP starting unit 240 requests an application checker (not shown) in the MFP starting unit 240 to check whether each of applications is allowed to run (Step S601). The application checker issues a system call to the OS 221 so that a request of acquiring the application start flag is issued (Step S602).

The OS 221 reads an application start flag from the NVRAM 104 based on the request (Steps S603 and S604). The OS 221 returns the acquired application start flag to the application checker (Step S605).

The application checker analyzes the application start flag acquired from the OS 221 (Step S606). Specifically, the application checker analyzes whether the application start flag for each application is set to “0” or “1”. When the application start flag is set to “1”, the application checker determines that the application is allowed to run.

The start process receives a determination result whether the application is allowed to run from the application checker (Step S607), and process control ends.

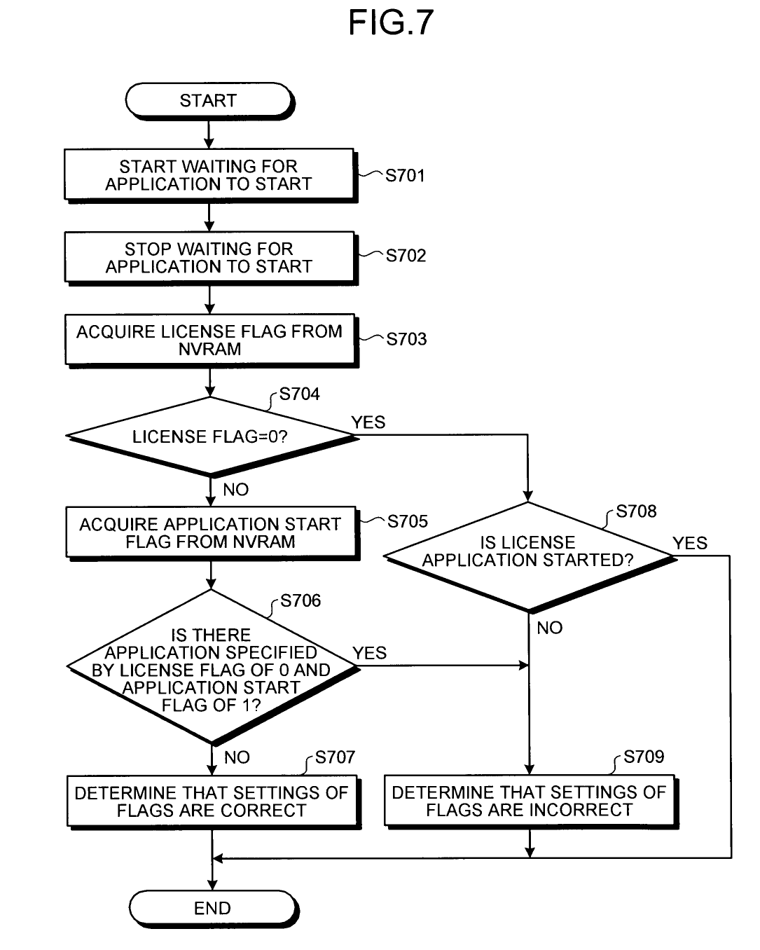

FIG. 7 is a flowchart of a flag determination process performed by the SCS 222 after the MFP starting unit 240 checks whether the application is allowed to run and then the application is actually started. In the flag determination process, the license flag and the application start flag are checked and it is determined whether a licensed application is started.

The SCS 222 starts waiting for each application to start by the application start process (Step S701). When the application that is allowed to run is actually started by the application start process described in connection with FIG. 5, the SCS 222 stops waiting for each application to start (Step S702).

The SCS 222 acquires a license flag from the NVRAM 104 (Step S703). The SCS 222 then determines whether the license flag is set to “0” (Step S704). Specifically, the SCS 222 determines whether all the bits in the license flag are set to “0”. That is, the SCS 222 determines whether a license process has been performed by the license issuing application 216.

When the license flag is not set to “0” (No at Step S704), the SCS 222 acquires an application start flag from the NVRAM 104 (Step S705). The SCS 222 determines whether an application specified by the license flag of “0” and the application start flag of “1” is present (Step S706). That is, the SCS 222 determines whether there is an application that is allowed to run although the application is not licensed.

When an application specified by the license flag of “0” and the application start flag of “1” is not present (No at Step S706), the SCS 222 determines that settings of the flags are correct. Then, the SCS 222 outputs a determination result indicating that the settings of the flags are correct (Step S707), and process control ends.

On the other hand, when an application specified by the license flag of “0” and the application start flag of “1” is present (Yes at Step S706), the SCS 222 determines that the settings of the flags are incorrect. The SCS 222 outputs error information indicating that the settings of the flags are incorrect (Step S709), and process control ends.

As described above, the license flag that indicates whether an application is licensed is stored in the NVRAM 104 in addition to a setting about validity of the application. Therefore, it is possible to check whether the setting of the validity of an application and the setting of a license of the application are consistent when starting the application.

After outputting the error information, the SCS 222 displays an error message on the operation panel 120, such that the SCS 222 disables all applications or disables only an application that is determined as an error. As a result, it is possible to prevent software from being fraudulently used by an operational error or fraudulent operation.

When the SCS 222 determines that the license flag is set to “0” (Yes at Step S704), the SCS 222 determines whether the license issuing application 216 is started (Step S708).

When the license issuing application 216 is started (Yes at Step S708), process control ends. In this case, the license issuing application 216 performs a license process (to be explained later).

When the license issuing application 216 is not started (No at Step S708), the license process cannot to be performed by the license issuing application 216. Therefore, the SCS 222 outputs error information indicating occurrence of an error (Step S709), and process control ends.

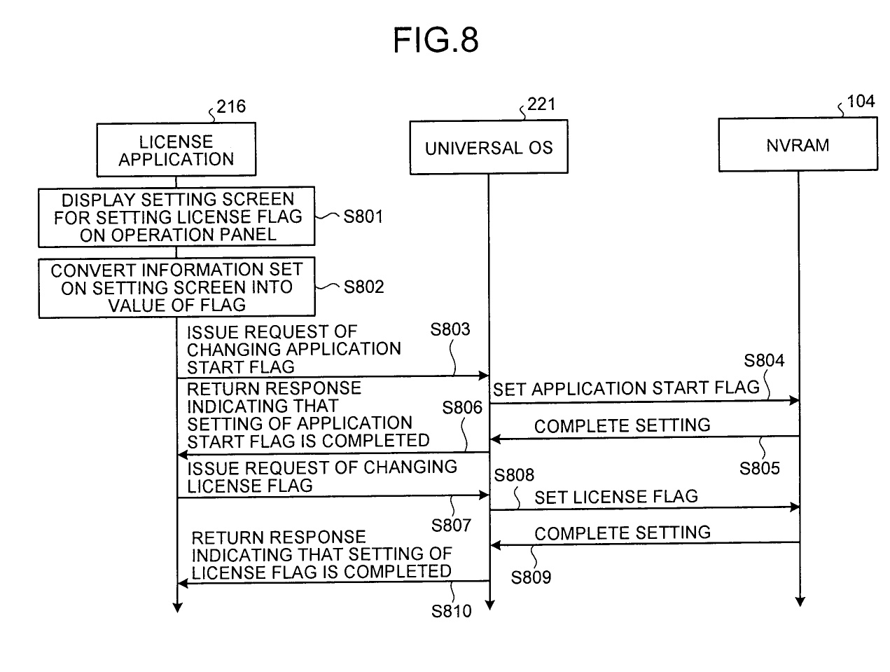

Explanation is given about the license process to be performed when the license issuing application 216 is started. FIG. 8 is a flowchart of the license process.

The license issuing application 216 displays a setting screen for setting the license flag and the application start flag on the operation panel 120 (Step S801). The setting screen contains items for setting validity of each of the license flag and the application start flag for each application.

The license issuing application 216 converts information indicating validity of each of the flags set on the setting screen into actual values of the flags (Step S802). Specifically, the license issuing application 216 sets a value of the flag to “1” when the flag is set as valid and to “0” when the flag is set as invalid.

The license issuing application 216 issues a system call to the OS 221 so that a request of changing the application start flag is issued (Step S803). The OS 221 sets the application start flag on the NVRAM 104 based on the request (Steps S804 and S805). The OS 221 then sends a notice indicating that a setting of the application start flag is completed to the license issuing application 216 (Step S806).

Similar to the above, the license issuing application 216 issues a system call to the OS 221 so that a request of changing the license flag is issued (Step S807). The OS 221 sets the license flag on the NVRAM 104 based on the request (Steps S808 and S809). The OS 221 then sends a notice indicating that a setting of the license flag is completed to the license issuing application 216 (Step S810).

The license process is performed only at once by the license issuing application 216 before the MFP 10 is delivered to a user (e.g., at a time of production or the like). Once the MFP 10 starts operation, only the application start flag can be changed under a particular condition, e.g., in a maintenance mode.

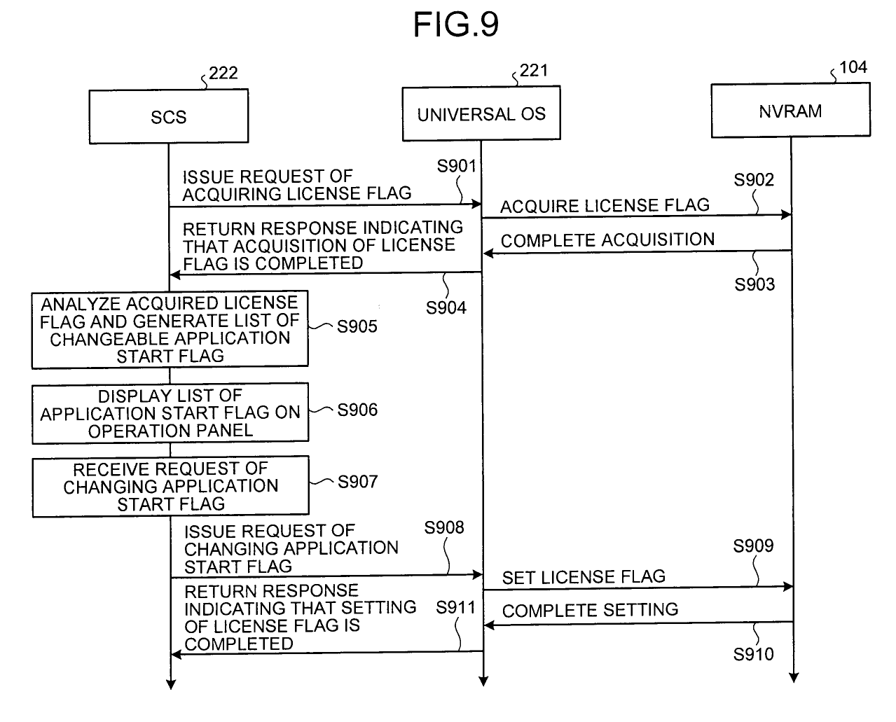

FIG. 9 is a flowchart of a start-flag change process performed after the MFP 10 starts operation. The start-flag change process is performed when a change of the application start flag is requested in a service maintenance mode. The service maintenance mode is a mode that can run after a predetermined password is entered by a user (e.g., a serviceman).

The SCS 222 issues a system call to the OS 221 so that a request of acquiring a license flag is issued (Step S901). The universal OS reads the license flag from the NVRAM 104 based on the request (Steps S902 and S903). Then, the OS 221 returns the acquired license flag to the SCS 222 (Step S904).

The SCS 222 analyzes the acquired license flag and generates a list of an application start flag that can be changed (Step S905). Specifically, the SCS 222 generates a list of an application start flag of an application of which license flag is set to “1” (valid).

The SCS 222 displays the generated list of the application start flag on the operation panel 120 such that a setting of the application start flag can be changed (Step S906). Therefore, a user (serviceman) can change the setting of the application start flag to invalidate a licensed application or revalidate an invalidated application.

The SCS 222 receives a request of changing the application start flag specified on the operation panel 120 (Step S907).

The SCS 222 issues a system call to the OS 221 so that a request of changing the application start flag is issued (Step S908). The OS 221 sets the application start flag on the NVRAM 104 based on the request (Steps S909 and S910). The OS 221 then sends a notice indicating that a setting of the application start flag is completed to the SCS 222 (Step S911), and process control ends.

As described above, the information processing apparatus according to the first embodiment stores the license flag and the application start flag in a nonvolatile memory and compares the flags with each other. Therefore, it is possible to check whether an application is to be fraudulently started. As a result, it is possible to reduce a fraudulent use of software by an operational error or the like. It is also possible to prevent extra license fees caused by a fraudulent use.

In the first embodiment, whether to start the license issuing application 216 that sets the license flag is controlled by a switch (the DIPSW 114). However, if a fraudulent user has a chance to obtain information about how to use the switch, that user can easily start the license issuing application 216 just by using the switch and may fraudulently change a setting of the license flag.

To prevent the above situation, an information processing apparatus according to a second embodiment of the present invention stores a switch flag in a nonvolatile memory and controls whether to start the license issuing application 216 based on the switch flag. Changing the switch flag is allowed only in a process maintenance mode that is enabled by entering a predetermined password.

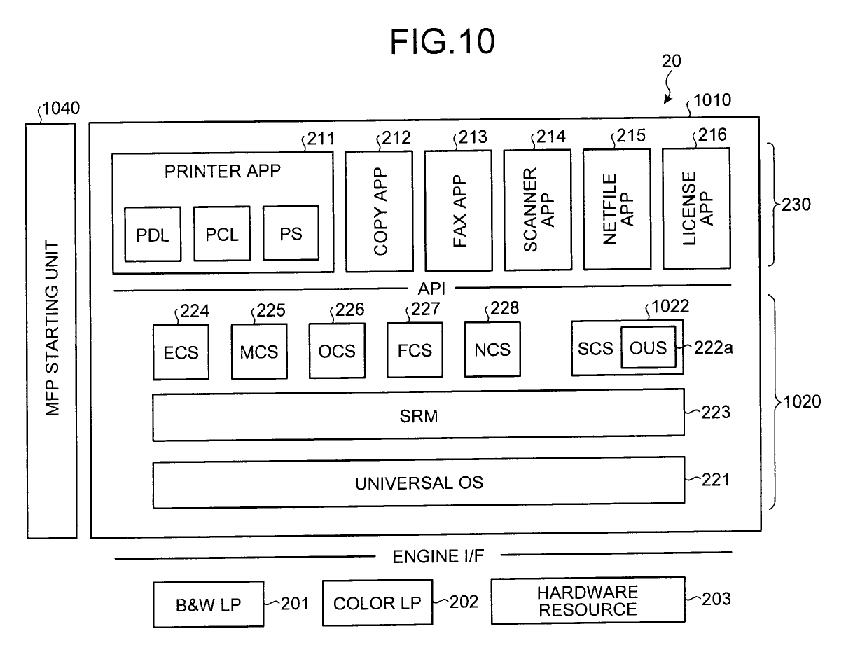

FIG. 10 is a functional block diagram of an MFP 20 according to the second embodiment. The MFP 20 is different from the MFP 10 in that an MFP starting unit 1040 and an SCS 1022 in a platform 1020 of a software group 1010 work differently from those of the MFP 10. Other configurations and functions of the MFP 20 are the same as those of the MFP 10, so that the same reference numerals are assigned to the same components and the same explanation is not repeated.

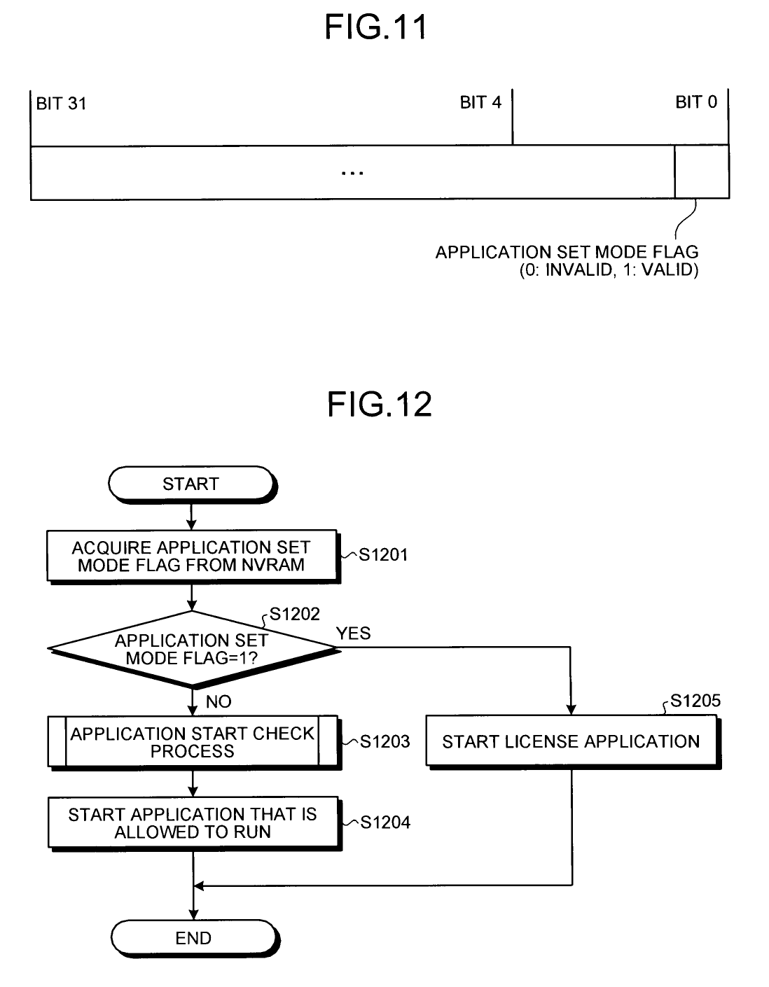

Although not shown in FIG. 10, an application set mode flag is stored in the NVRAM 104. The application set mode flag indicates whether the license issuing application 216 is allowed to run. FIG. 11 is a schematic diagram of a data structure of the application set mode flag.

The application set mode flag is stored in a 1-bit area within a predetermined 32-bit area in the NVRAM 104. The application set mode flag indicates validity of the license issuing application 216 such that the license issuing application 216 is not allowed to run (invalid) when a bit is set to “0” and allowed to run (valid) when a bit is set to “1”.

Referring back to FIG. 10, the MFP starting unit 1040 starts the license issuing application 216 not based on the setting of the DIPSW 114 as the MFP starting unit 240 does but based on the application set mode flag that is set to “1”.

The SCS 1022 enters the process maintenance mode when a predetermined password is entered, and controls processing of changing the application set mode flag in the process maintenance mode. The process maintenance mode is different from the service maintenance mode to be used by a serviceman. That is, functions that are not allowed in the service maintenance mode can be executed in the process maintenance mode.

FIG. 12 is a flowchart of an application start process performed by the MFP 20.

The MFP starting unit 1040 acquires an application set mode flag from the NVRAM 104 (Step S1201). The MFP starting unit 1040 determines whether the application set mode flag is set to “1”, that is, whether the license issuing application 216 is allowed to run (Step S1202).

When the application set mode flag is not set to “1” (No at Step S1202), the MFP starting unit 1040 performs the same application start check process as described in the first embodiment (Step S1203), and starts an application that is allowed to run (Step S1204).

When it is determined that the application set mode flag is set to “1” (Yes at Step S1202), the MFP starting unit 1040 starts the license issuing application 216 (Step S1205), and process control ends.

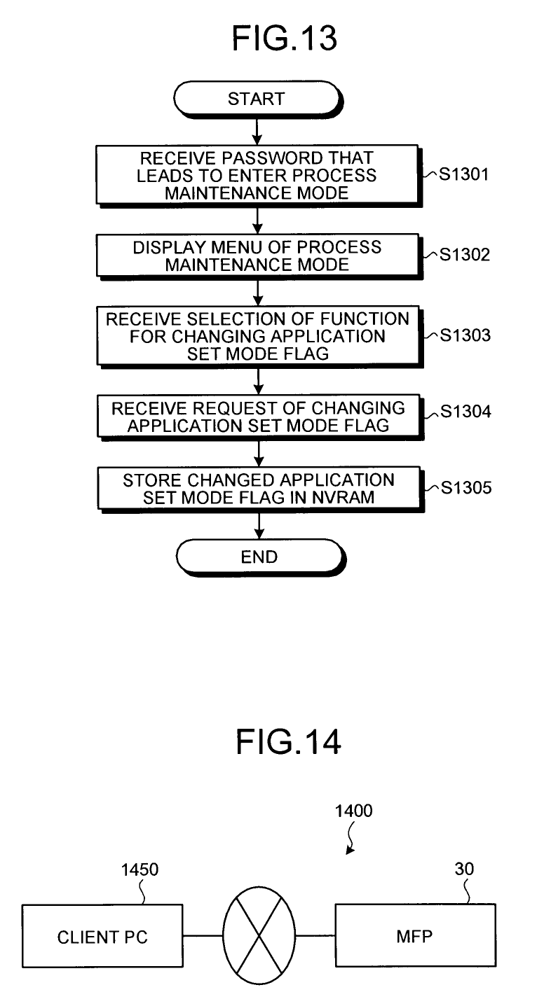

FIG. 13 is a flowchart of a set flag change process performed in the process maintenance mode for changing the application set mode flag.

The SCS 1022 receives a password that leads to enter the process maintenance mode (Step S1301). The SCS 1022 then displays a menu of the process maintenance mode (Step S1302).

The SCS 1022 receives selection of a function for changing the application set mode flag specified from the menu of the process maintenance mode by a user (Step S1303). The SCS 1022 then receives a request of changing the application set mode flag specified by the user (Step S1304). The SCS 1022 changes the application set mode flag based on the request and stores the changed application set mode flag in the NVRAM 104 (Step S1305). Then, process control ends.

Processes other than the application start process (i.e., the application start check process, the flag determination process, the license process, and the start-flag change process) of the second embodiment are the same as those of the first embodiment, and the same explanation is not repeated.

As described above, the image processing apparatus according to the second embodiment stores the switch flag in a nonvolatile memory and determines whether to start the license issuing application based on the switch flag. Changing the switch flag is allowed only in the process maintenance mode that is enabled by entering a predetermined password. Therefore, it is possible to prevent the license issuing application from being fraudulently started and prevent a fraudulent change of the license flag and the application start flag.

A third embodiment of the present invention is described below. An information processing apparatus according to the third embodiment performs the license process via a network to prevent a fraudulent change of the license flag and the application start flag caused by a fraudulent start of a license issuing application.

FIG. 14 is a schematic diagram of a network configuration of a communication system 1400 according to the third embodiment. The communication system 1400 includes an MFP 30 and a client personal computer (PC) 1450 connected to the MFP 30 via a network. The client PC 1450 accesses the MFP 30 to execute the license process. The client PC 1450 includes a function for accessing the MFP 30 using protocol such as telnet or HTTP. The communication system 1400 can include a plurality of the client PCs 1450.

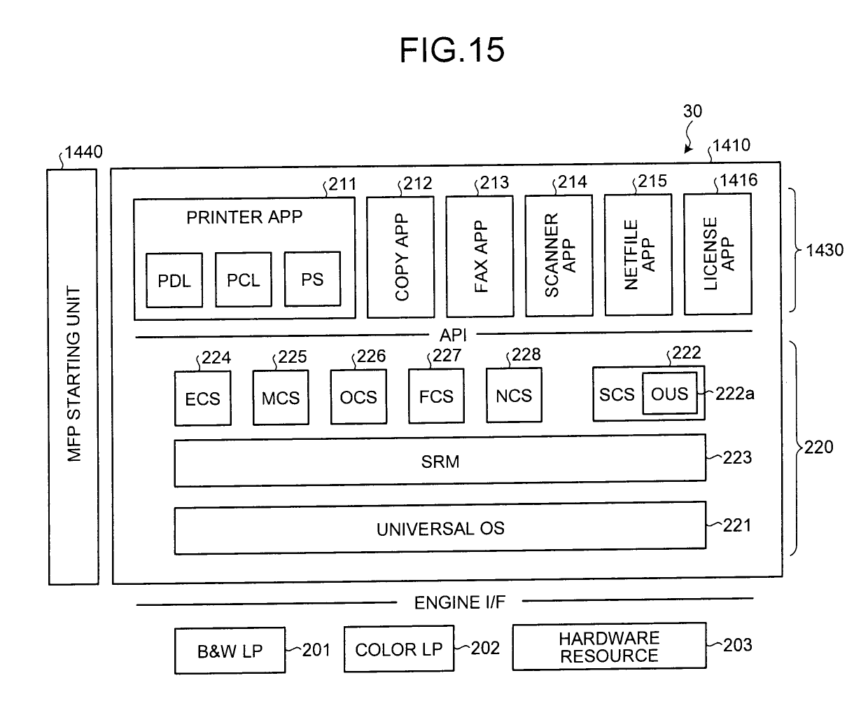

FIG. 15 is a functional block diagram of the MFP 30. The MFP 30 is different from the MFP 10 in that an MFP starting unit 1440 and a license issuing application 1416 in an application 1430 of a software group 1410 work differently from those of the MFP 10. Other configurations and functions of the MFP 30 are the same as those of the MFP 10, so that the same reference numerals are assigned to the same components and the same explanation is not repeated.

The MFP starting unit 1440 always starts the license issuing application 1416 unlike the MFP starting unit 240 of the first embodiment. That is, the MFP starting unit 1440 always starts the license issuing application 1416 regardless of a setting of the DIPSW 114.

The license issuing application 1416 is different from the license issuing application 216 in that the license issuing application 1416 allows the client PC 1450 to perform the license process via the NCS 228. That is, the license issuing application 1416 can transmit and receive a command and data related to the license process using protocol such as telnet or HTTP via a network.

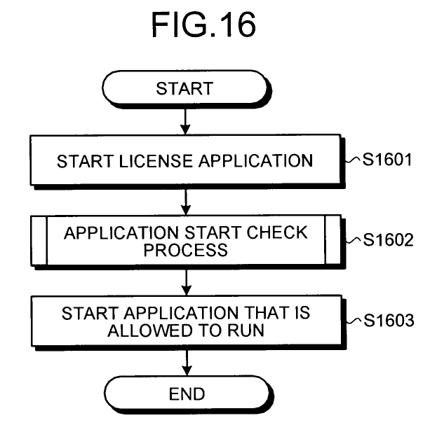

FIG. 16 is a flowchart of an application start process performed by the MFP 30.

The MFP starting unit 1440 starts the license issuing application 1416 (Step S1601). Then, the MFP starting unit 1440 performs the same application start check process as described in the first embodiment (Step S1602). The MFP starting unit 1440 starts an application that is allowed to run (Step S1603), and process control ends.

Thus, according to the third embodiment, the license issuing application 1416 is always started. The started license issuing application 1416 performs the license process based on a request from the client PC 1450.

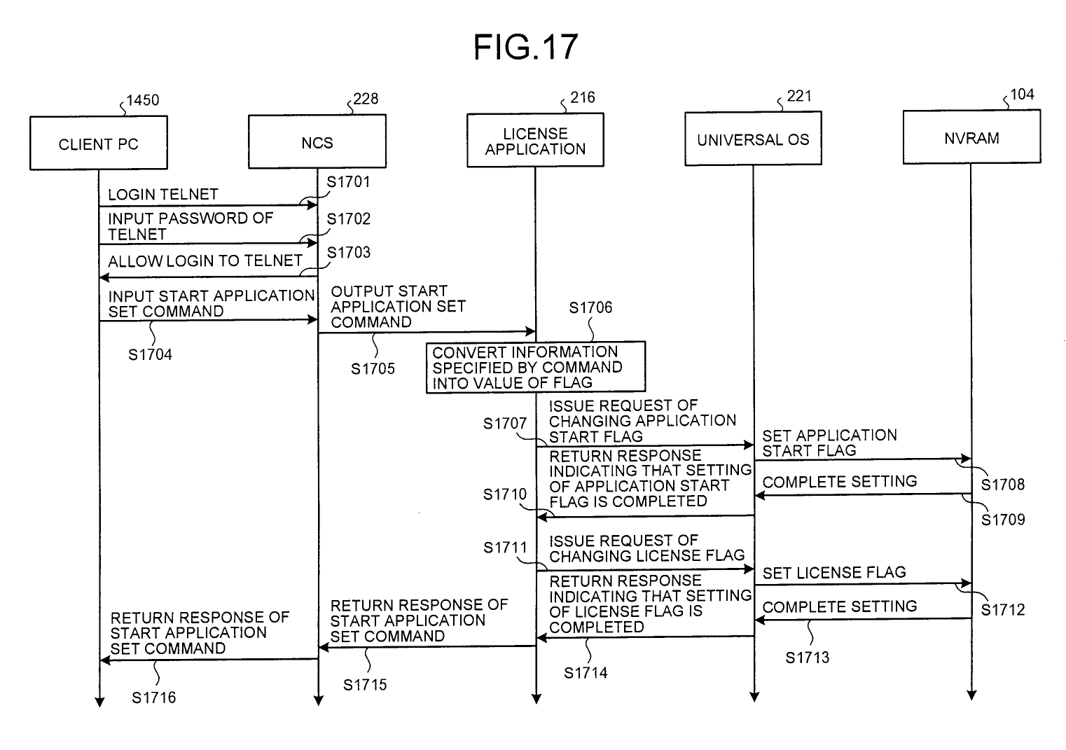

FIG. 17 is a flowchart of a license process performed by the MFP 30. In the below example, the license process is performed based on an access to the MFP 30 using telnet. Other protocols can be used for performing the license process instead of telnet.

The client PC 1450 issues a telnet login request to the NCS 228 (Step S1701). The client PC 1450 transmits a user ID and a password of the telnet to the NCS 228 (Step S1702). The NCS 228 authenticates the user ID and the password. When the user ID and the password are authenticated, the NCS 228 sends a login permission notice to the client PC 1450 (Step S1703).

The client PC 1450 transmits a start application set command to the NCS 228 (Step S1704). The start application set command is a request message containing information indicating values of a license flag and an application start flag that are to be set, so that a request of performing the license process based on the information is issued.

The NCS 228 sends a received start application set command to the license issuing application 1416 (Step S1705). The license issuing application 1416 converts information specified by the start application set command into a value of the flags (Step S1706).

Processes from Steps S1707 to S1714 are the same as the processes from Steps S803 to S810 described in connection with FIG. 8, and therefore, the same explanation is not repeated.

The license issuing application 1416 transmits a notice indicating that a setting of the flag corresponding to the start application set command is completed to the client PC 1450 via the NCS 228 (Steps S1715 and S1716), and process control ends.

Processes other than the application start process and the license process (i.e., the application start check process, the flag determination process, and the start-flag change process) of the third embodiment are the same as those of the first embodiment, and the same explanation is not repeated.

As described above, the information processing apparatus according to the third embodiment performs the license process via a network. Therefore, it is possible to prevent a fraudulent change of the license flag and the application start flag caused by a fraudulent start of a license issuing application.

In the first to the third embodiments, the license issuing application is stored in a USB memory within the MFP together with other applications. Therefore, if information about how to start the license issuing application leaks, it is difficult to prevent a fraudulent start of the license issuing application.

To prevent the above situation, an information processing apparatus according to a fourth embodiment of the present invention stores a license issuing application in a secure digital (SD) card that is a removable nonvolatile storage medium. Therefore, the license issuing application is executed only when the SD card is mounted on the information processing apparatus.

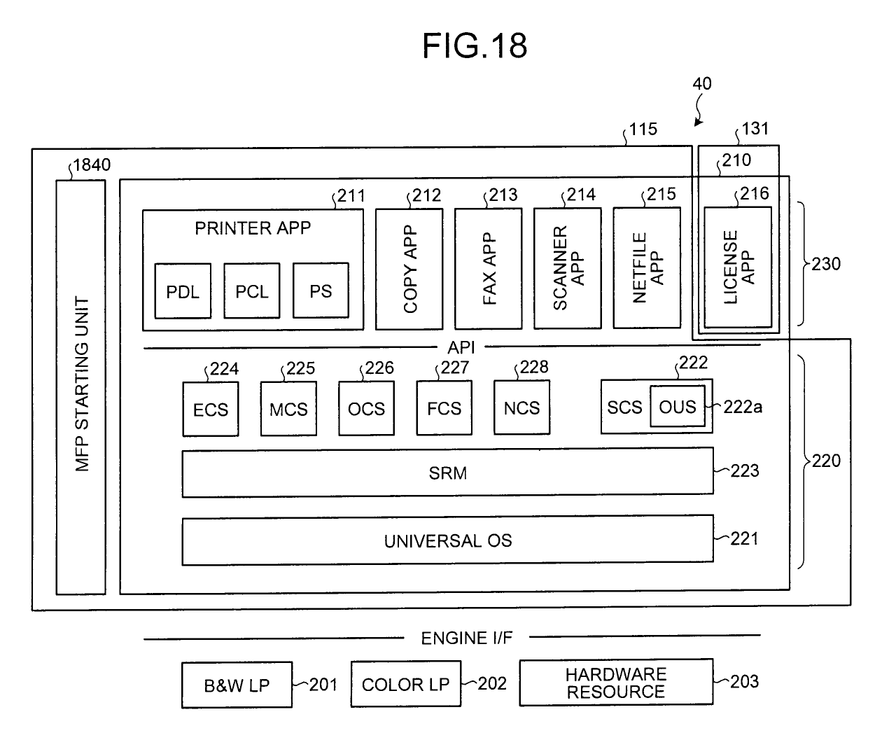

FIG. 18 is a functional block diagram of an MFP 40 according to the fourth embodiment. In the MFP 40, a function of an MFP starting unit 1840 is different from that of the first embodiment. Other configurations and functions of the MFP 40 are the same as those of the MFP 10, so that the same reference numerals are assigned to the same components and the same explanation is not repeated.

Furthermore, the license issuing application 216 is stored in the SD card 131 while other applications and control services are stored in the USB memory 115.

The MFP starting unit 1840 starts the license issuing application 216 based on determination whether the SD card 131 is mounted on the MFP 40 and whether the license issuing application 216 is stored in the SD card 131, instead of determination on the setting of the DIPSW 114. Thus, when the SD card 131 is mounted on the MFP 40 and the license issuing application 216 is stored in the SD card 131, the MFP starting unit 1840 starts the license issuing application 216.

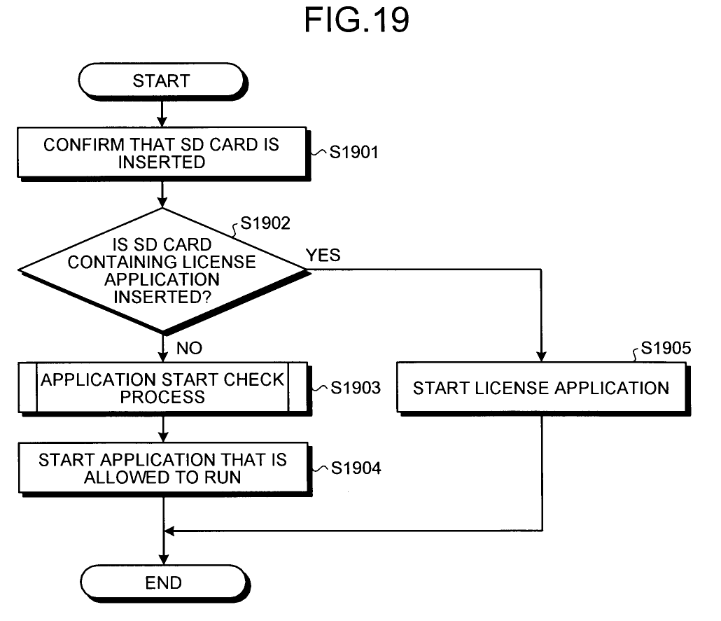

FIG. 19 is a flowchart of an application start process performed by the MFP 40.

The MFP starting unit 1840 confirms that the SD card 131 is mounted on the MFP 40 (Step S1901). The MFP starting unit 1840 then determines whether the SD card 131 containing the license issuing application 216 is mounted on the MFP 40 (Step S1902).

When the SD card 131 containing the license issuing application 216 is not mounted on the MFP 40 (No at Step S1902), the MFP starting unit 1840 performs the application start check process (Step S1903). Then, the MFP starting unit 1840 starts an application that is allowed to run (Step S1904), and process control ends.

When the SD card 131 containing the license issuing application 216 is mounted on the MFP 40 (Yes at Step S1902), the MFP starting unit 1840 starts the license issuing application 216 (Step S1905), and process control ends.

Processes other than the application start process (i.e., the application start check process, the flag determination process, the license process, and the start-flag change process) of the fourth embodiment are the same as those of the first embodiment, and the same explanation is not repeated.

As described above, the information processing apparatus according to the fourth embodiments stores the license issuing application in a removable SD card, so that the license issuing application is executed only when the SD card is mounted on the information processing apparatus. Therefore, it is possible to prevent a fraudulent change of the license flag and the application start flag caused by a fraudulent start of a license issuing application.

According to an aspect of the present invention, validity of a setting about whether software is allowed to run is checked. Therefore, it is possible to prevent a fraudulent use of the software by an operational error.

Furthermore, according to another aspect of the present invention, it is possible to prevent a fraudulent use of an application that sets license information of software.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a first storage unit that stores therein license information that indicates whether an application is licensed and permission information that indicates whether an application is allowed to start;
a starting unit that starts an application for which the permission information is stored in the first storage unit;
a determining unit that acquires license information of a running application from the first storage unit and determines whether acquired license information indicates that the application is licensed; and
an outputting unit that outputs error information when the acquired license information does not indicate that the running application is licensed.

2. The information processing apparatus according to claim 1, wherein the starting unit starts a license issuing application that stores specified license information and permission information in the first storage unit.

3. The information processing apparatus according to claim 2, further comprising a drive unit to which a storage medium that stores therein the license issuing application is inserted in a removable manner, wherein
the starting unit starts the license issuing application from the storage medium inserted in the drive unit.

4. The information processing apparatus according to claim 2, further comprising:
a second storage unit that stores therein the license issuing application; and
a switching unit that designates whether to start the license issuing application, wherein
the starting unit determines whether the license issuing application is designated to start by the switching unit, and when it is determined that the license issuing application is designated to start, starts the license issuing application from the second storage unit.

5. The information processing apparatus according to claim 2, further comprising:
a second storage unit that stores therein the license issuing application; and
a third storage unit that stores therein start information indicating whether to start the license issuing application, wherein
the starting unit determines whether the start information indicates to start the license issuing application, and when it is determined that the start information indicates to start the license issuing application, starts the license issuing application from the second storage unit.

6. The information processing apparatus according to claim 5, further comprising a changing unit that receives a request for changing the start information, changes the start information for which a change is requested, and stores changed start information in the third storage unit.

7. The information processing apparatus according to claim 6, wherein the changing unit further receives a password, determines whether the password matches with a preset password, and when it is determined that the password matches with the preset password, receives the request for changing the start information.

8. The information processing apparatus according to claim 2, further comprising:
a second storage unit that stores therein the license issuing application;
a receiving unit that receives a request message that contains the license information, the permission information, and a request for storing the license information and the permission information in the first storage unit, wherein
the starting unit starts the license issuing application from the second storage unit, and
the license issuing application stores the license information and the permission information included in the request message in the first storage unit.

9. The information processing apparatus according to claim 2, wherein
the determining unit further determines whether the license information is stored in the first storage unit, and
the information processing apparatus further comprises an operation receiving unit that receives, when the determining unit determines that the license information is not stored in the first storage unit, an operation for the license issuing application.

10. The information processing apparatus according to claim 9, wherein
when the license information is not stored in the first storage unit, the determining unit further determines whether the license issuing application is running, and
when the determining unit determines that the license issuing application is not running, the outputting unit outputs error information.

11. The information processing apparatus according to claim 1, further comprising a changing unit that receives a request for changing the permission information, changes the permission information in response to the request, and stores changed permission information in the first storage unit.

12. The information processing apparatus according to claim 11, wherein the changing unit displays permission information of a licensed application on a display unit, receives a request for changing the permission information displayed on the display unit, changes the permission information in response to the request, and stores changed permission information in the first storage unit.

13. An information processing method comprising:
starting an application for which the permission information that indicates whether an application is allowed to start is stored in a storage unit that stores therein license information that indicates whether an application is licensed and permission information;
determining including
acquiring license information of a running application from the storage unit, and
determining whether acquired license information indicates that the application is licensed; and
outputting error information when the acquired license information does not indicate that the running application is licensed.

14. An image processing apparatus including a plurality of applications for processing an image using hardware resources, an operating system, and a control unit that runs on the operating system to control the hardware resources in response to an access from each of the applications, the image processing apparatus comprising:
a storage unit that stores therein license information that indicates whether an application is licensed and permission information that indicates whether an application is allowed to start;
a starting unit that starts an application for which the permission information is stored in the storage unit;
a determining unit that acquires license information of a running application from the storage unit and determines whether acquired license information indicates that the application is licensed; and
an outputting unit that outputs error information when the acquired license information does not indicate that the running application is licensed.
